(19) United States
(12) Patent Application Publication
(10) Pub. No.: US 2010/0333103 A1
(43) Pub. Date: Dec. 30, 2010

(54) INFORMATION PROCESSOR AND INFORMATION PROCESSING METHOD

(76) Inventors: Naomiki Kobayashi, Tokyo (JP); Hiroki Iwahara, Tokyo (JP); Jun Sato, Tokyo (JP); Keisuke Yasui, Tokyo (JP); Fumio Yoshiya, Tokyo (JP); Keiko Watanabe, Tokyo (JP); Jun Ohashi, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/795,544

(22) Filed: Jun. 7, 2010

(30) Foreign Application Priority Data
Jun. 30, 2009 (JP) 2009-155451

(51) Int. Cl. G06F 9/50

(52) U.S. Cl. 718/104

(57) ABSTRACT

According to one embodiment, an information processor includes a management module that manages a plurality of register areas in a host controller for processing data protected by copyright. The register areas store confidential information for copyright protection. The management module includes a use state management module and a release module. The use state management module manages use state information on whether the register areas are used by existing process tasks. When all the register areas are occupied by the existing process tasks and a new process task requests for the use of a register area to perform a process based on the confidential information, the release module releases a register area occupied by one of the existing process tasks according to the use state information to assign the register area to the new process task.

### CROSS-REFERENCE TO RELATED APPLICATIONS

This application is based upon and claims the benefit of priority from Japanese Patent Application No. 2009-155451, filed Jun. 30, 2009, the entire contents of which are incorporated herein by reference.

### BACKGROUND

1. Field

One embodiment of the invention relates to an information processor and information processing method for processing data protected by copyright.

2. Description of the Related Art

Host controllers have been used to process data (video data, audio data, etc.) protected by copyright. Among the host controllers are those for a memory card (for example, SD card) with a copyright protection function. Such a host controller stores sensitive information such as a cipher key in a register area in the hardware to perform processing related to authentication with an SD card, encryption/decryption of content stored in an SD card, and the like (see, for example, Japanese Patent Application Publication (KOKAI) No. 2000-357126). Since the processing, such as authentication with an SD card and encryption/decryption of content, is performed in the hardware (for example, application-specific integrated circuit (ASIC), field-programmable gate array (FPGA), etc.), security can be enforced against the leakage of sensitive or confidential information, and also the central processing unit (CPU) load on the host can be reduced.

However, a limited number of registers that store confidential information necessitate a limitation on the number of applications (process tasks) using the register areas that can be activated simultaneously. Besides, if an application (a process task) abnormally ends, the register area remains occupied.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a system configuration of a host controller according to an embodiment of the invention;

FIG. 2 is an exemplary diagram of a structure of a key bank illustrated in FIG. 1 in the embodiment;

FIG. 3 is an exemplary diagram of upper applications (process tasks) using the host controller and software modules in the embodiment;

FIG. 4 is an exemplary diagram of a structure of middleware illustrated in FIG. 3 in the embodiment;

FIGS. 5 and 6 are exemplary sequence diagrams of the operation between an upper application (a process task) and a lower host controller in the embodiment;

FIG. 7 is an exemplary sequence diagram of the operation of the middleware to acquire the use state of key banks by polling in the embodiment; and

FIG. 8 is an exemplary perspective view of a personal computer (PC) as a specific example of an information processor in the embodiment.

### DETAILED DESCRIPTION

Various embodiments according to the invention will be described hereinafter with reference to the accompanying drawings. In general, according to one embodiment of the invention, an information processor comprises a management module configured to manage a plurality of register areas in a host controller for processing data protected by copyright. The register areas store confidential information for copyright protection. The management module comprises a use state management module and a release module. The use state management module is configured to manage use state information on whether the register areas are used by existing process tasks. The release module is configured to, when all the register areas are occupied by the existing process tasks and a new process task requests for a register area to perform a process based on the confidential information, release a register area occupied by one of the existing process tasks according to the use state information to assign the register area to the new process task.

According to another embodiment of the invention, there is provided an information processing method applied to an information processor comprising a controller. The information processing method is performed by the controller and comprises managing a plurality of register areas in a host controller for processing data protected by copyright. The register areas store confidential information for copyright protection. The managing comprises: managing use state information on whether the register areas are used by existing process tasks; and releasing, when all the register areas are occupied by the existing process tasks and a new process task requests for a register area to perform a process based on the confidential information, a register area occupied by one of the existing process tasks according to the use state information to assign the register area to the new process task.

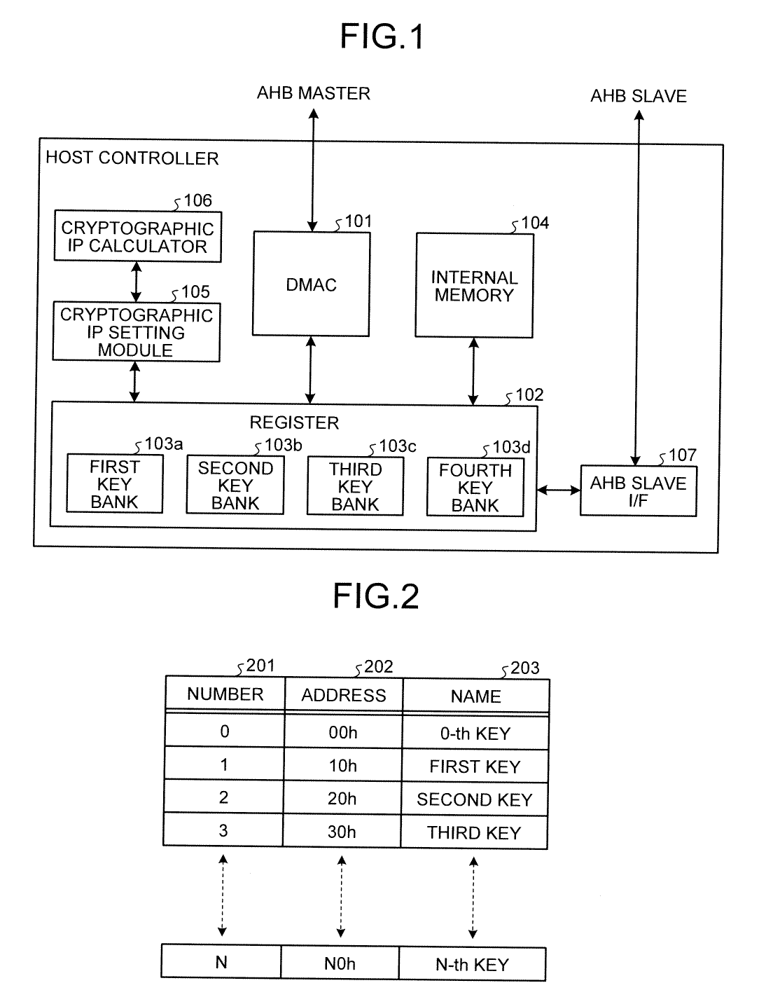

A description will be given of a system configuration of a host controller used in an information processor according to an embodiment of the invention. FIG. 1 is a block diagram of the system configuration of the host controller according to the embodiment.

As illustrated in FIG. 1, the host controller comprises a direct memory access controller (DMAC) 101, a register 102, an internal memory 104, a cryptographic intellectual property (IP) setting module 105, and a cryptographic IP calculator 106. The host controller transfers data to a secure storage device (not illustrated in FIG. 1) such as an SD card with a copyright protection function via the DMAC 101 connected to an advanced high-performance bus (AHB) master. The register 102 is connected to the cryptographic IP setting module 105. Under the control of the cryptographic IP setting module 105, the cryptographic IP calculator 106 performs various types of calculations based on cipher key information stored in the register 102 or the like.

The register 102 comprises first to fourth key banks 103a, 103b, 103c, and 103d for storing sensitive information such as cipher keys. The register 102 is also connected to an AHB slave via an AHB slave interface (I/F) 107. Although four key banks are illustrated in FIG. 1, this is by way of example only. The number of key banks is not limited to four. The internal memory 104 temporarily stores various types of confidential information calculated by the cryptographic IP calculator 106 based on cipher key information stored in the first to fourth key banks 103a to 103d. The internal memory 104 is an area that cannot be referred to from software such as a driver. Incidentally, the host controller of the embodiment is implemented as hardware.

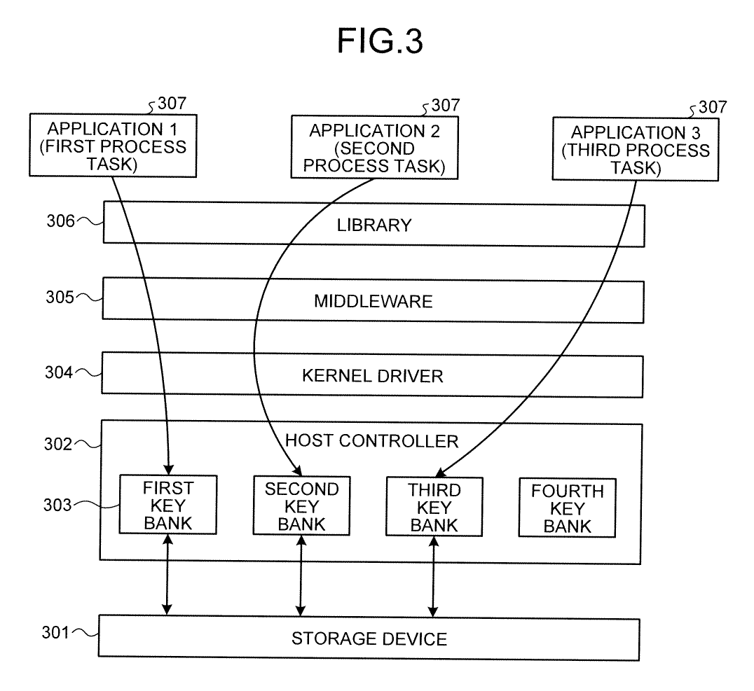

A description will be given of the structure of the first to fourth key banks 103a to 103d. FIG. 2 illustrates the detailed structure of the first to fourth key banks 103a to 103d. The first to fourth key banks 103a to 103d can each store a plurality of types of keys. The area can be identified by a reference number 201 assigned thereto, a reference address 202 in the register 102, and a use name (name) 203. Each of the first to fourth key banks 103a to 103d corresponds to one upper application (process task). That is, the first to fourth key banks 103a to 103d are in one-to-one correspondence to upper applications.

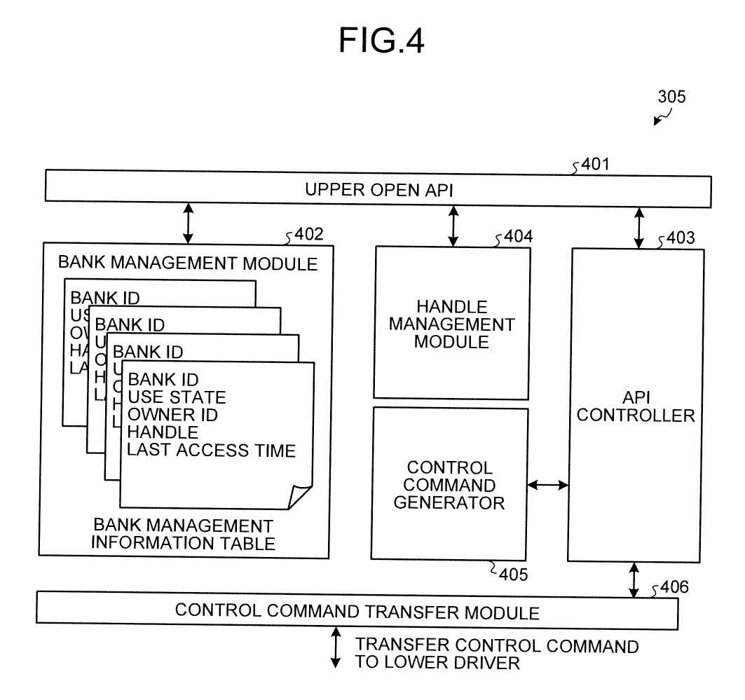

A description will be given of the upper applications (process tasks) using the host controller and software modules interposed therebetween. FIG. 3 is a diagram of upper applications (process tasks) 307 using a storage device 301 and a host controller 302, and various types of software modules interposed therebetween.

The plurality of process tasks 307 concurrently use the host controller 302. Each of the process tasks 307 occupies one of key banks 303. In the example of FIG. 3, the first process task 307 occupies the first key bank 303. Similarly, the second and the third process tasks 307 occupy the second and the third key banks 303, respectively. The upper layer of the host controller 302 is a kernel driver 304. The kernel driver 304 provides an interface to middleware 305 to transfer a control command to the host controller 302. The middleware 305 is a layer that shields the interface to the kernel driver 304 depending on an operating system (OS). The middleware 305 is located between the kernel driver 304 and a library 306. The middleware 305 manages the assignment of the key banks 303 of the host controller 302 to process tasks 307, respectively.

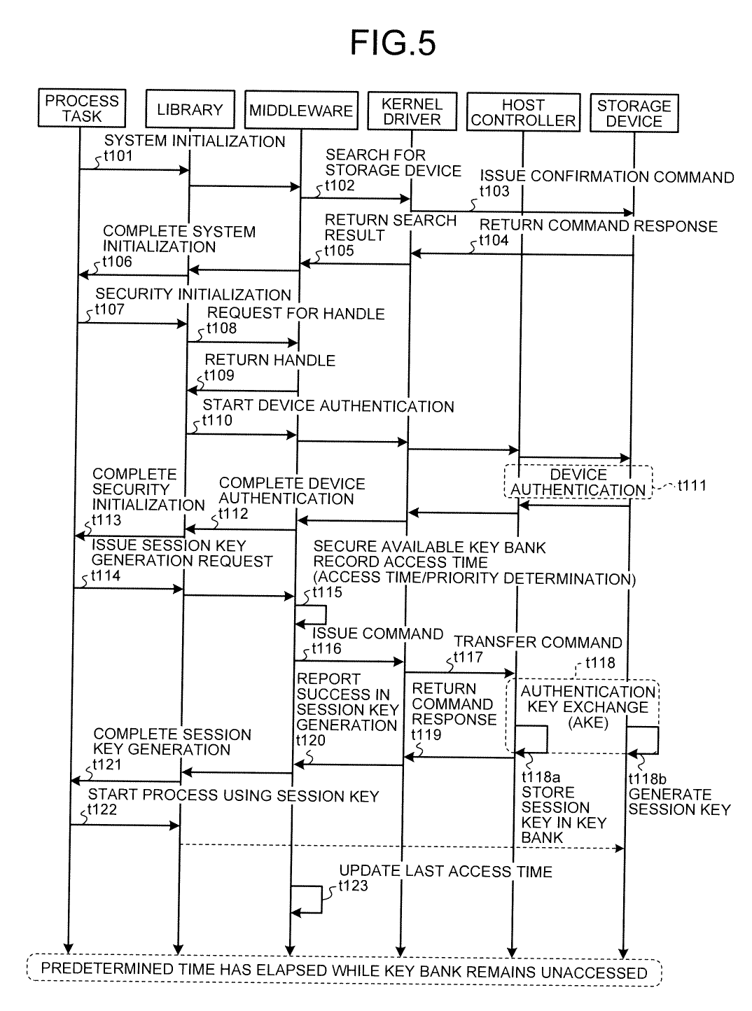

A description will be given of the internal structure of the middleware 305. FIG. 4 illustrates the internal structure of the middleware 305.

The middleware 305 comprises an upper open application programming interface (API) 401, a bank management module 402, an API controller 403, a handle management module 404, a control command generator 405, and a control command transfer module 406. The upper open API 401 is an interface to the library 306. If implemented so as to call a common API provided by the upper open API 401, the upper library 306 can be developed independently of a platform. The bank management module 402 manages the assignment of a key bank to each process task. The bank management module 402 is provided with a bank management information table. The bank management information table includes fields for ID of a bank to be managed, use state (used/not used), handle assigned to a process task, owner ID (for example, process ID) of the process task that uses the handle, and last access time.

Each time a process task uses a key in a key bank, access time is updated in the bank management information table. If a new process task requests for the use of a key bank, i.e., the use of the register, when all the key banks are in use, the bank management module 402 refers to the last access time in the bank management information table. If there is a key bank that has not been accessed for a predetermined period of time, the bank management module 402 releases the key bank to assign it to the new process task. Thus, the limited number of key banks can be effectively shared among a plurality of process tasks.

The case where a key bank has not been accessed for a predetermined period of time includes the case where a process task has not accessed the register area because there has been no need for the access during the process and the case where a process task has abnormally ended and has not accessed the register area. In the case where a process task has abnormally ended, the corresponding register area is to be released. Thus, the register area can be prevented from being occupied by the process task.

While the last access time is described above as an index to determine a key bank to be released when there is no available key bank, the key bank may be determined based also on the priority of each application and each process task (the priority of each content may also be taken into account). In the case of taking into account the priority, the bank management module 402 releases a key bank occupied by a process task lower in priority than a new process task, and assigns the key bank to the new process task. The priority may be preset as a default, or may be set by a user input.

Some process tasks may need to always secure the register area. Therefore, the process tasks can issue a “storage drive lock command” to always secure the register area. Upon receipt of the storage drive lock command, the middleware 305 does not release the register area regardless of the above conditions on the last access time and the priority. Further, the process tasks can issue a “storage drive lock release command” to release the lock of the register area secured by the storage drive lock command. Upon receipt of the storage drive lock release command, the middleware 305 operates in a manner as described above with respect to the register area.

The middleware 305 is implemented as a dynamic library. Besides, the bank management information table is shared information that is referred to by all processes involving the loading of the middleware 305. Accordingly, the bank management information table is managed in a shared memory space.

The handle management module 404 assigns a handle to each process task for each initialization operation. The API controller 403, the control command generator 405, and the control command transfer module 406 control the host controller 302. In response to a request received by the API controller 403 through the upper open API 401, the control command generator 405 generates a control command. The control command generated by the control command generator 405 is output via the API controller 403 to the control command transfer module 406. The control command transfer module 406 transfers the control command to the lower driver (the kernel driver 304) that drives the host controller 302.

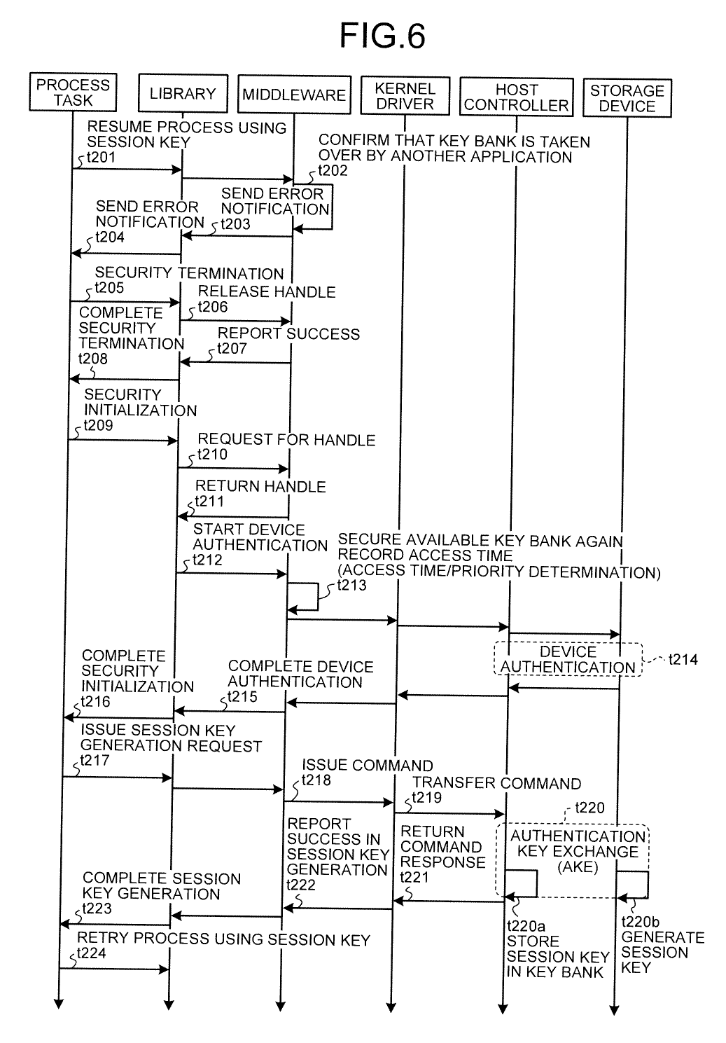

With reference to FIG. 5, a description will be given of the operation between an upper application (a process task) and a lower host controller. FIG. 5 is a schematic sequence diagram of the operation between an upper application (a process task) and a lower cryptographic IP core. Specifically, the processes performed by a library, middleware, and a kernel driver are implemented when various types of programs installed thereon are invoked in response to a request or a command and executed by the controller, such as a central processing unit (CPU), of the information processor of the embodiment. A process task, a library, middleware, and a kernel driver illustrated in FIGS. 5 to 7 correspond to the process task 307, the library 306, the middleware 305, and the kernel driver 304 described above, respectively.

When invoked, the process task performs system initialization. A request for the system initialization is transferred from the process task to the middleware via the library (t101). The middleware searches for a storage device connected to the information processor (t102). At this point, the middleware outputs a search command for the storage device to the kernel driver, and the kernel driver issues a confirmation command to the storage device via the host controller (t103). The storage device outputs a response to the confirmation command to the kernel driver through the host controller (t104). The kernel driver returns a search result to the middleware (t105). The search result is sent from the middleware to the process task via the library. Thus, the system initialization is completed (t106).

Next, the process task acquires a handle to be required in the following process as security initialization. Specifically, the process task outputs a request for security initialization to the library (t107). Upon receipt of the request, the library requests the middleware for a handle (t108). In response to the request, the middleware returns a handle to the library (t109). The handle is an equivalent for ID to identify the unit of processing. That is, the unit of processing can be identified in the following process by issuing a handle.

Having acquired the handle, the library requests the host controller to start device authentication through the middleware and the kernel driver (t110). Accordingly, the host controller performs the device authentication with the storage device to authenticate each other (t111). In response to a request for security initialization from the process task to the library, and a device authentication start command issued from the library to the host controller through the middleware and the kernel driver, the device authentication starts. The device authentication is performed based on confidential information stored in the register of the host controller. A key generated in the process of the device authentication is stored in a key bank as in the conventional technology.

As the device authentication is performed in the manner described above, the middleware that manages the register area as one of the functions is required to previously secure a key bank upon receipt of the device authentication request. The middleware of the embodiment manages the assignment of a key bank based on the bank management information table (see 402 in FIG. 4). If a new process task requests for the use of a key bank when all key banks are in use, as described above, the middleware refers to the last access time in the bank management information table. If there is a key bank that has not been accessed for a predetermined period of time, the middleware releases the key bank to assign it to the new process task. Alternatively, if a key bank is occupied by a process task lower in priority than the new process task, the middleware releases the key bank to assign it to the new process task. Thus, the limited number of key banks can be effectively shared among a plurality of applications (process tasks).

If the device authentication is successful, the result is returned from the host controller to the middleware through the kernel driver. The middleware notifies the library of the completion of the device authentication (t112). The library notifies the process task of the completion of the security initialization (t113). If the device authentication is not successful, the process task cannot use the storage device.

If the device authentication is successful, the process task issues a session key generation request to the middleware via the library (t114). Having secured an available key bank, the middleware issues a session key generation command to the kernel driver (t115, t116). The kernel driver transfers the session key generation command to the host controller (t117). Upon receipt of the session key generation command, the host controller exchanges key exchange messages with the storage device by challenge-response, and generates a session key (t118a, t118b). The session key thus generated is stored in the key bank previously secured by the middleware.

Since the session key has been successfully generated, a response to the session key generation command is sent from the host controller to the middleware through the kernel driver to notify the middleware of success in the generation of the session key (t119, t120). Upon receipt of the response, the middleware notifies the process task through the library that the session key generation is completed (t121). After that, the process task starts the process using the session key as in the conventional technology (t122). The middleware located between the process task and the host controller updates the last access time each time the key bank is accessed (t123). The last access time is utilized as described above.

Even when a process task is assigned a key bank, and a session key is generated and stored in the key bank, if the key bank has not been accessed for a predetermined period of time, the key bank may be taken over by another process task. A description will then be given of the process of retrieving a key bank taken over by another process task. FIG. 6 is a sequence diagram of the process of retrieving a key bank taken over by another process task.

When the process task resumes the process using the session key through the library (t201), the middleware confirms, in this example, that the key bank assigned to the process task has been taken over by another process task, i.e., another application (t202). As a result, the middleware sends an error notification (an error code) to the process task via the library to notify the process task that the key bank has been taken over by another process task (t203, t204).

Having received the error notification, the process task is notified that the key bank has been taken over, and sends a request to the library for security termination (t205). Upon receipt of the request, the library requests the middleware to release the handle (t206). When receiving a response (success) from the middleware (t207), the library notifies the process task of the completion of the security termination (t208). Thereafter, the process task requests again for security initialization. After the middleware secures an available key bank based on the bank management information table, device authentication is performed. The host controller exchanges key exchange messages with the storage device, and generates a session key. The process from t209 to t223 corresponds to the process from t107 to t121 previously described in connection with FIG. 5. Upon completion of the process, the process task can resume the process using the session key.

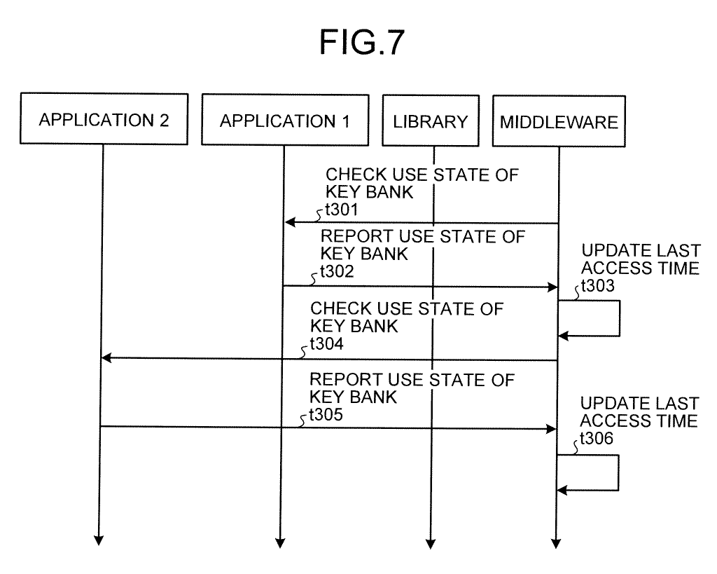

In the following, a description will be given of the operation of the middleware to acquire the use state of key banks by polling for process tasks with reference to FIG. 7. FIG. 7 is a sequence diagram of the operation of the middleware to acquire the use state of key banks by polling for upper applications (process tasks).

The middleware invokes resident tasks for polling, and inquires each application (process task) about the use state of the key bank at regular time intervals (t301, t302, t304, t305). The middleware manages the information thus obtained using the bank management information table. When receiving a response to the polling from a process task that the key bank is in use, the middleware writes the time to the bank management information table as the last access time (t303, t306). On the other hand, when receiving a response that the key bank is not in use, the middleware deletes an entry corresponding to the owner ID of the process task from the bank management information table. The last access time in this example may be used as an index to determine a key bank to be released. In this case also, key banks can be managed to be shared as described above.

A description has been given of the operation between an upper application (a process task) and a lower host controller (and a storage device). In the above description, the middleware manages key banks. The process related to security is preferably performed by a lower layer, and may be performed by the kernel driver or the host controller. However, the use of the middleware is advantageous compared to the kernel driver in that the configuration does not depend on a platform. Besides, compared to the host controller implemented in hardware, the use of the middleware is advantageous in terms of the cost.

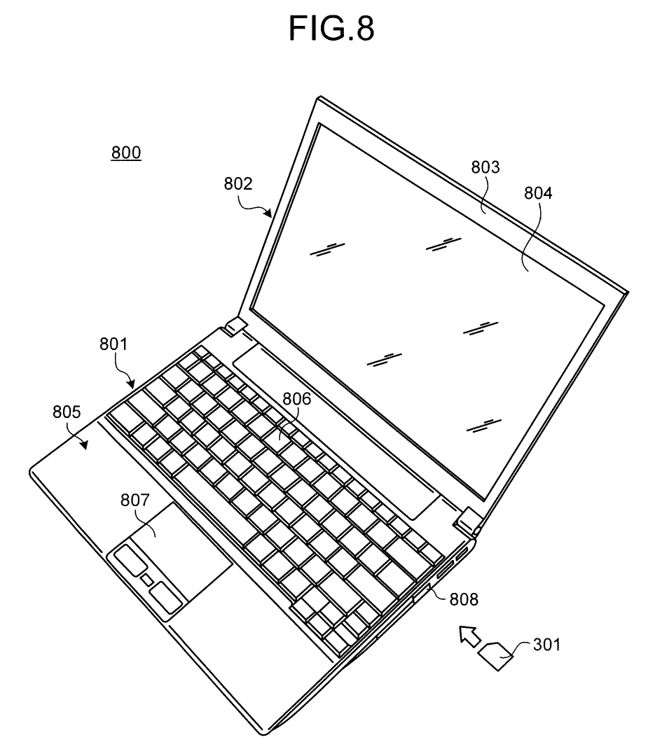

With reference to FIG. 8, a description will be given of a personal computer (PC) as an example of the information processor of the embodiment. FIG. 8 is a perspective view of a PC 800 as an example of the information processor of the embodiment.

As illustrated in FIG. 8, the PC 800 comprises a main body 801 and a display module 802. The display module 802 comprises a display housing 803 and a display panel 804 housed in the display housing 803.

The main body 801 comprises a housing 805, a keyboard 806, and a touchpad 807 as a pointing device. The housing 805 houses a main circuit board, a host interface, an optical disk device (ODD) unit, a card slot, and the like.

The card slot is provided on a sidewall of the housing 805. An opening 808 of the card slot is formed on the sidewall. The user can insert the storage device 301 such as a memory card including an SD card into the housing 805 through the opening 808.

While the information processor of the embodiment is described above as being applied to a PC, this is by way of example and not of limitation. The information processor of the embodiment may be applied to any device having the function of processing data protected by copyright, such as a mobile telephone, a personal digital assistant (PDA), a digital still camera, a digital television receiver, and the like.

The above computer software (programs), such as application, library, middleware, and kernel driver, may be provided as being stored in advance in a read only memory (ROM), a hard disk drive (HDD), or the like. The computer program may also be provided as being stored in a computer-readable storage medium, such as a compact disc-read only memory (CD-ROM), a flexible disk (FD), a compact disc recordable (CD-R), a digital versatile disc (DVD), and a memory card including an SD card as a file in an installable or executable format. The computer program may also be stored in a computer connected via a network such as the Internet so that it can be downloaded therefrom via the network to be provide or distributed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising a management module configured to manage a plurality of register areas in a host controller for processing data protected by copyright, the register areas storing confidential information for copyright protection, wherein the management module comprises:
a use state management module configured to manage use state information on whether the register areas are used by existing process tasks; and
a release module configured to, when all the register areas are occupied by the existing process tasks and a new process task requests for a register area to perform a process based on the confidential information, release a register area occupied by one of the existing process tasks according to the use state information to assign the register area to the new process task.

2. The information processor of claim 1, wherein
the use state management module is configured to record a last access time with respect to each of the register areas when each process task starts the process based on the confidential information, and
the release module is configured to release the register area upon determining that the register area has not been accessed for a predetermined period of time based on the last access time corresponding to the one of the existing process tasks.

3. The information processor of claim 2, wherein the use state management module is configured to obtain the use state information by polling for each process task, and update the last access time with respect to a register area occupied by the process task.

4. The information processor of claim 1, wherein
the use state management module is configured to manage priority of each process task, and
the release module is configured to release the register area upon determining that the one of the existing process tasks that occupies the register area is lower in priority than the new process task.

5. The information processor of claim 1, wherein, when a register area assigned to a first process task is taken over by a second process task, and the first process task resumes process based on the confidential information stored in the register area, an available register area, if any, is secured to start a new session.

6. The information processor of claim 1, wherein, when the one of the existing process tasks that occupies the register area has issued a storage drive lock command, the release module does not release the register area regardless of the use state information.

7. The information processor of claim 6, wherein, upon receipt of a storage drive lock release command from the one of the existing process tasks that has issued a storage drive lock command, the release module release lock of the register area.

8. An information processing method applied to an information processor comprising a controller, the information processing method performed by the controller and comprising managing a plurality of register areas in a host controller for processing data protected by copyright, the register areas storing confidential information for copyright protection, wherein the managing comprises:
managing use state information on whether the register areas are used by existing process tasks; and
releasing, when all the register areas are occupied by the existing process tasks and a new process task requests for a register area to perform a process based on the confidential information, a register area occupied by one of the existing process tasks according to the use state information to assign the register area to the new process task.
